(19) United States
(12) Patent Application Publication
(10) Pub. No.: US 2025/0232039 A1
(43) Pub. Date: Jul. 17, 2025

(54) Efficiently Scalable Assurance Assessment for Hard 3PIP

(71) Applicants: Luke Gilles, Centerville, OH (US); Joshua Toth, Maineville, OH (US); Tyler Moody, Fairborn, OH (US)

(72) Inventors: Luke Gilles, Centerville, OH (US); Joshua Toth, Maineville, OH (US); Tyler Moody, Fairborn, OH (US)

(73) Assignee: Tenet 3, LLC, Dayton, OH (US)

(21) Appl. No.: 18/666,108

(22) Filed: May 16, 2024

(51) Int. Cl. G06F 21/57

(52) U.S. Cl. CPC G06F 21/577; G06F 2221/034

(57) ABSTRACT

Solutions for efficiently scalable assurance assessments for hard third party intellectual property (3PIP) are disclosed. Examples parse a data file (e.g., a netlist, GDSII, or OASIS) identifying components and connections for a functional component of an integrated circuit (e.g., ASIC, FPGA) and generate a graph having nodes and edges corresponding to the components and connections. Subgraph matching identifies portions of the graph that match subgraphs in a library of known secure functionality. Unmatched portions are then further analyzed for security, such as by extracting a schematic, performing a Boolean analysis, or performing a circuit simulation. When all portions of the data file are found to be secure, the data file is flagged and the integrated circuit may be fabricated or programmed.

### BACKGROUND

Similarly to how software libraries provide functionality to software developers, third-party IP (3PIP) packages provide functionality that microelectronic engineers can integrate into their designs. The 3PIP packages can be delivered either hard or soft, where hard packages may be a flattened transistor netlist, a behavioral model and, occasionally, a layout file. A soft package, which more closely resembles a software library, may comprise hardware description language (HDL) code.

When the 3PIP is delivered as a soft package, several verification options are available. Some tools perform a security focused analysis directly on the HDL code. Others use formal verification techniques to mathematically prove that synthesized logic is logically equivalent to the HDL or prove user-defined assertions are true or false. Others leverage digital simulation and emulation to ensure that the design will function correctly under expected conditions and use cases. However, all of these have the same fundamental short comings. They all operate in the digital domain, providing little, if any, insight into the analog domain. And also, it is currently computationally infeasible to fully verify the design using these tools, even in the digital domain.

For hard 3PIP packages (i.e., already compiled packages), verification options significantly more limited. Simulations can be performed using the transistor netlist or behavioral models, although analog SPICE simulations run on transistor netlists are even more computationally complex than the digital simulations performed on soft 3PIP. Behavioral simulations are more scalable but only approximate the 3PIP which potentially hides functionality, intentionally or not. If the layout file is available, it is possible to run layout versus schematic (LVS), design rule checks, and electrical rule checks. Unfortunately, none of these are intended to verify the functionality of the 3PIP.

Thus 3PIP delivered as a hard macro (hard3PIP) permits little insight into its implementation, limiting verification to options that can only study the expected behavior of 3PIP. This is insufficient to find unexpected or adversarial functionality, making hard 3PIP a potential vehicle for introducing malicious logic in a Trojan horse type approach.

### BRIEF DESCRIPTION OF THE DRAWINGS

The disclosed examples are described in detail below with reference to the accompanying drawing figures listed below:

FIG. 1 illustrates an exemplary architecture for performing security assurance of hard third party intellectual property (3PIP) for an integrated circuit, in a manner that is advantageously scalable.

FIG. 2 illustrates generating a graph from a data file of hard 3PIP, as may occur when using examples of the architecture of FIG. 1.

FIG. 3 illustrates subgraph matching, as may occur when using examples of the architecture of FIG. 1.

FIG. 4 illustrates further detail for the security assessment functionality of the architecture of FIG. 1.

FIG. 5 illustrates a flowchart of exemplary operations associated with examples of the architecture of FIG. 1.

FIG. 6 illustrates a block diagram of a computing device suitable for implementing various aspects of the disclosure.

### DETAILED DESCRIPTION

Solutions for efficiently scalable assurance assessments for hard third party intellectual property (3PIP) are disclosed. Examples parse a data file, such as a netlist, graphic data stream (GDS) formatted file (e.g., GDSII), or an open artwork system interchange standard (OASIS) formatted file. This identifies components (i.e., primitives, such as transistors, diodes, resistors, capacitors, and inductors) and connections for a functional component of an integrated circuit. The integrated circuit may be a custom-built chip, an application-specific integrated circuit (ASIC), or a field programmable gate array (FPGA). A graph is generated, having nodes and edges corresponding to the components and connections. Subgraph matching identifies portions of the graph that match subgraphs in a library of subgraphs which are known to have secure functionality. Unmatched portions are then further analyzed for security, such as by extracting a schematic, performing a Boolean analysis, or performing a circuit simulation. When all portions of the data file are found to be secure, the data file is flagged and the integrated circuit may be fabricated (ASIC) or programmed (FPGA). Some examples then extend the library of subgraph with the newly-analyzed portion(s) of the graph.

A novel approach to security assurance for hard 3PIP leverages both functional and structural analysis. In a design inspection phase of the approach, the 3PIP is cast as a graph where nodes are devices and edges are the interconnects, as defined in the 3PIP netlist or layout file. The devices are primitives (transistors, capacitors, resistors, etc.), gates, and blocks. A novel graph search technology maps substructures of the graph to a library of common circuits that, by definition of the 3PIP, should be present. Primitives in the 3PIP design that are not mapped to a library device are flagged for review.

The design inspection approach is developed to address the shortcomings of state-of-the-art 3PIP verification tools for hard 3PIP macros. Design inspection casts the netlist as a property graph and opens the door to performing advanced graph analytics, including subgraph matching (SGM). SGM enables rapidly identify pre-verified subcircuits within the 3PIP. In doing so, primitives are mapped to known good functions, potentially leaving additional or modified primitives unmatched. These unmatched subgraphs can then be extracted and visualized for analysis. There are five major subprocesses: library creation, netlist parsing, graph creation, SGM, and results analysis.

The format of the 3PIP upon delivery determines what preparation is required. If it is delivered as a flat, transistor-level SPICE (or similar) netlist, no preparation is required. However, in the case that only a GDSII file is available, then the netlist must be extracted. This may be accomplished using an open-source or commercial LVS or parasitic extraction tool. Once the netlist is obtained the netlist parsing, graph creation, and SGM subprocesses may be performed.

The Library Creation subprocess provides the set of subcircuits being searched for in the 3PIP. Subcircuits may be added to the library from several sources, including standard cell libraries and common implementations of analog and mixed-signal (AMS) designs. Additionally, as described below the process builds the library over time as new hard 3PIP is assessed and found to be secure. Some examples use known malicious logic as a library of subcircuits to flag as insecure.

To generate the library, flat netlists of the query sub-circuits are parsed and converted into property graphs. A modified version of the SGM subprocess is then performed on each subcircuit graph to create a query “signature.” These signatures capture the subcircuit's primitives, as well as its internal connectivity, and are stored in the library and used to identify subcircuits during the SGM subprocess.

While the SPICE netlist of the 3PIP fully describes a system, its format is not conducive to performing scalable pattern matching. Therefore, in the netlist parsing and graph creation subprocesses, the netlist is read and converted into a property graph, enabling the use of advanced subgraph matching algorithms. The graph has two data types: nodes, representing primitive devices such as transistors, resistors, and capacitors; and nets, representing the connections between primitives. As each line of the netlist is read, a new node for the corresponding primitive is created. The node's properties capture the physical characteristics of the primitive as provided in the netlist, namely the SPICE model, width, and length. If additional information is provided, such as primitive coordinates, that also can be captured as node properties. The connectivity of each primitive is also read and captured using the net data type. The net data type is a list that tracks the primitives to which it is connected. As each connection is parsed, a check is performed to ascertain whether the corresponding net already exists in the graph. If it does, the primitive is added to the list, otherwise, a new net is created first. Once the netlist is fully parsed and the graph is fully defined, the SGM subprocess is performed.

The SGM subprocess provides the core functionality of the design inspection. It is during this subprocess that subgraphs of the 3PIP graph are matched to the query cells stored in the query library. Determining the number of matches for all library subcircuits may be performed, for typically-sized hard 3PIP data files, in a matter of minutes using currently-available, common computational resources. In general, memory requirements scale linearly with the number of primitives. This process rapidly identifies all instances of the cells in the query library and isolates any unmatched circuitry for further security review.

When circuitry is unmatched, there is a risk of malicious logic, although it may also be a simple result of a gap in the library. The library contains standard cell libraries, analyst-defined subcircuits, and subcircuits identified as secure in previous assessments of other 3PIP. With continued use, the likelihood of gaps in the library decreases.

For unmatched circuitry, depending on the complexity, visualization (using an extracted schematic) may enable determination of security. For example, if all transistors have the same length and widths and are consistent for both n- and p-types, this may indicate that the circuit is secure, whereas unexpected variations in the physical properties may indicate malicious modification (i.e., a stealthy implementation of a parametric Trojan). When attempting to determine whether a circuit is malicious, other circuits to which it is connected provide an indication. For example, if a circuits is connected to anything that is not common, within a certain number of “hops” of intervening circuitry, this may be an indication of malicious activity.

Boolean analysis for unmatched circuitry provides further capability to perform analysis on an complex unmatched digital circuits. While it will only work on digital circuits, it can save a significant amount of time and effort when compared to manual analysis. Boolean analysis determines whether a circuit is sequential or combinatorial. A simulation is then performed on the graph and outputs are generated. For sequential circuits, the output is a timing diagram; for combinatorial circuits, the output is a boolean function and a truth table.

Analog functional analysis uses a SPICE simulator to perform analog simulation of unmatched circuitry. This is useful in cases where boolean analysis fails, and for analog circuits. Analog functional analysis is able to identify an unmatched circuit as benign by ensuring it has no unexpected behavior in the analog domain. If these verification processes reveal no concerns, the unmatched circuit may be flagged as benign, along with all other identical circuits.

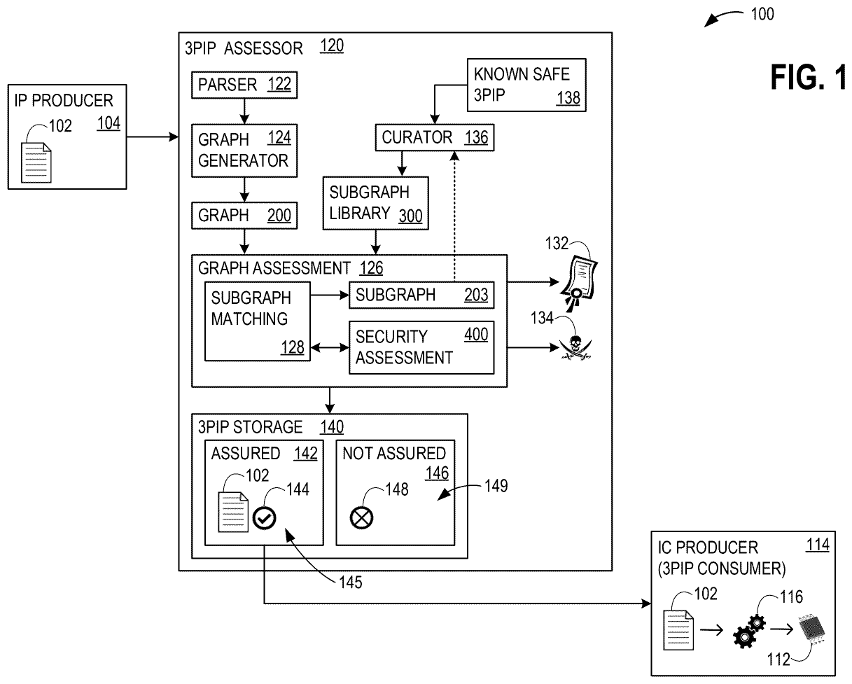

Turning now to the figures, FIG. 1 illustrates an exemplary architecture 100 for performing security assurance of hard 3PIP in a data file 102, in a manner that is advantageously scalable. Data file 102 is provided by an IP provider 104 and comprises a netlist, a GDS formatted file (e.g., GDSII), or an OASIS formatted file hard 3PIP that is to be used for an integrated circuit 112. An IP assessor 120 performs an assurance assessment on data file 102 to certify it as secure so that an integrated circuit producer 114 is willing to produce integrated circuit 112 using data file 102.

That is, integrated circuit producer 114 is a consumer of 3PIP, but looks to IP assessor 120 for assurance that data file 102 does not contain problematic content, such as malicious logic. When integrated circuit producer 114 is confident in the content of data file 102, integrated circuit producer 114 uses an IC fabrication/programming component 116 to building integrated circuit 112. Integrated circuit 112 may be an ASIC, an FPGA, a custom VLSI chip, or another circuit technology.

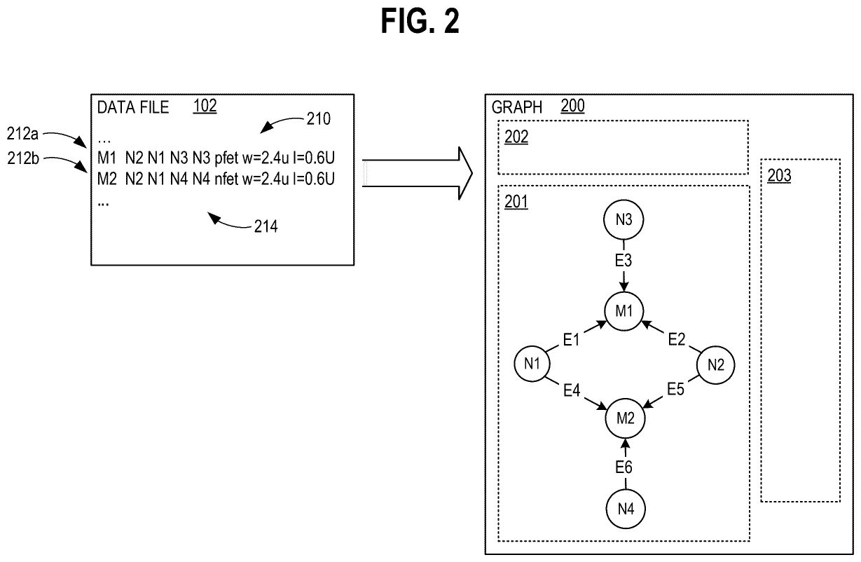

IP assessor 120 has multiple tools, including a data file parser 122, a graph generator 124, and a graph assessment 126 (e.g., a graph assessor component). Data file parser 122 parses data file 102 to identify primitives and connections of the primitives, examples of which are shown in FIG. 2 and described below. Graph generator 124 generates graph 200, in which the nodes of graph 200 correspond to the primitives and the edges of graph 200 correspond to connections of the primitives. Examples of are shown in FIG. 2 and described below.

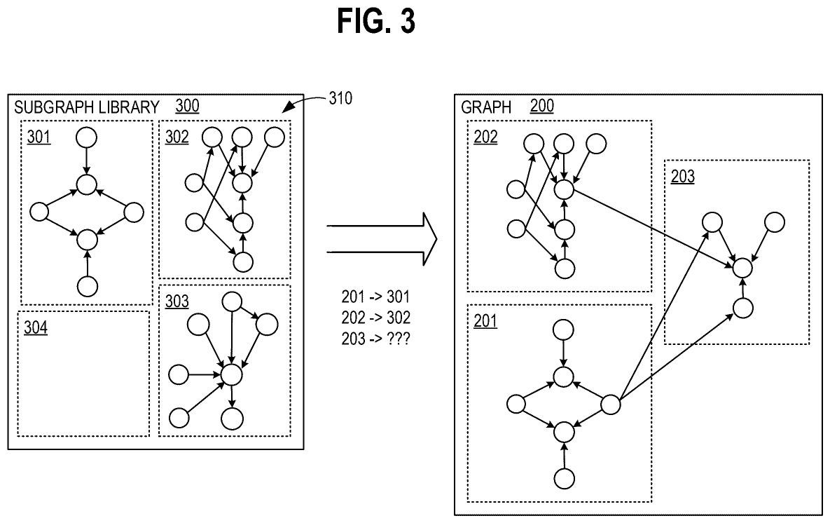

Graph assessment 126 uses a subgraph matching 128 (a matching component) to attempt matching portions of graph 200 with subgraphs in a subgraph library 300 of known secure 3PIP functionality 138. This is shown in FIG. 3 and described in further detail below, and identifies portions of graph 200 that match subgraphs in subgraph library 300. These matching portions are deemed to be secure, having been assessed during some prior security assessment. If every portion of graph 200 matches a subgraph in subgraph library 300, graph assessment 126 generates an alert 132 that data file 102 is secure. Integrated circuit producer 114 may receive alert 132, in some scenarios.

Alternatively, on in addition, graph assessment 126 may cause data file 102 to be persisted in a 3PIP storage 140, which is shown as having two separated portions: an assured storage portion 142, reserved for data files known to be secure, and a not-assured storage portion 146, reserved for data files not known to be secure (or known to be not secure). In some examples, a flag 144 is persisted with known secure data files, and a flag 148 is persisted with data files not known to be secure. In some examples, the storage location within assured storage portion 142 or flag 144 forms an indication 145 that data file 102 is secure, in the event that integrated circuit producer 114 retrieves data file 102 from 3PIP storage 140. In some examples, the storage location within not-assured storage portion 146 or flag 148 forms an indication 149 that a data file is not secure.

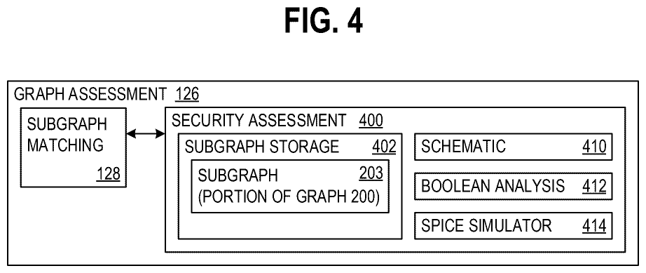

If, however, a portion of graph 200 cannot be matched to a subgraph of subgraph library 300 (which is shown as a subgraph 203 and later as an unmatched portion 203), a security assessment 400 is performed on the unmatched portion as shown in FIG. 4, and described in further detail below. Security assessment 400 determines whether each unmatched portion of graph 200 is secure. When (if) all portions of graph 200 are identified as secure, graph assessment 126 generates alert 132 and/or persists data file in assured storage portion 142, such as with flag 144. Additionally, any previously-unmatched portion of graph 200 that passes security assessment 400 (i.e., is identified as secure by security assessment 400), is sent to a library curator 136 that adds the newly-identified portion of graph 200 to subgraph library 300.

When an unmatched portion of graph 200 cannot be identified as secure, or is identified as not secure graph assessment 126 generates an alert 134 that data file 102 is not secure. Integrated circuit producer 114 may receive alert 134, in some scenarios, and thus knows to not use data file 102.

FIG. 2 illustrates generating graph 200 from data file 102. The content of data file 102 is used to generate graph 200. Graph 200 is shown as having three subgraphs: a portion 201, a portion 202, and a portion 203. Data file 102 has a section 210 that corresponds to portion 201. Portions 201-203 are subgraphs, but are labeled differently for clarity when describing FIG. 3 below.

Section 210 of data file 102 has primitives 212a and 212b, with connections 214. In some examples, primitives in data file may be circuit elements such as transistors, diodes, resistors, capacitors, and inductors. In some examples, connections 214 have multiple sources and destinations. As illustrated, primitive 212a is identified as M1 connecting to N1, N2, and N3, as shown. Primitive 212b is identified as M2 connecting to N2, N1, and N4, as shown.

For example, M1 is a node of portion 201 (which means that it is also a node of graph 200) and connects to another node N1 with an edge E1, connects to another node N2 with an edge E2, and connects to another node N3 with an edge E3. M2 is a node of portion 201 and connects to node N1 with an edge E4, connects to node N2 with an edge E5, and connects to another node N4 with an edge E6

FIG. 3 illustrates subgraph matching using subgraph library 300. Subgraph library 300 has a plurality of subgraphs 310 with a subgraph 301, a subgraph 302, and a subgraph 303. Portion 201 of graph 200 matches subgraph 301 of subgraph library 300 and portion 202 of graph 200 matches subgraph 302 of subgraph library 300. No portion of graph 200 matches subgraph 303 of subgraph library 300, and no subgraph of subgraph library 300 matches portion 203 of graph 200. Thus, portion 203 of graph 200 is unmatched portion 203. Subgraph 304 is shown as a placeholder in subgraph library 300 for when library curator 136 later adds unmatched portion 203 (after unmatched portion 203 is found to be secure).

FIG. 4 illustrates further detail for security assessment 400. Subgraph matching 128 sends unmatched portion 203 to security assessment 400 after failing to match unmatched portion 203 with any subgraph of subgraph library 300. In some examples, as a result of the failure to find a match, unmatched portion 203 is stored in a subgraph storage 402 for retrieval by security assessment 400. Security assessment 400 may use any of multiple approaches to assess the security of unmatched portion 203, such as by extracting a schematic 410 of unmatched portion 203, performing a Boolean analysis 412 of unmatched portion 203, or performing a circuit simulation 414 of unmatched portion 203 (e.g., an analog circuit simulation, such as a SPICE simulation).

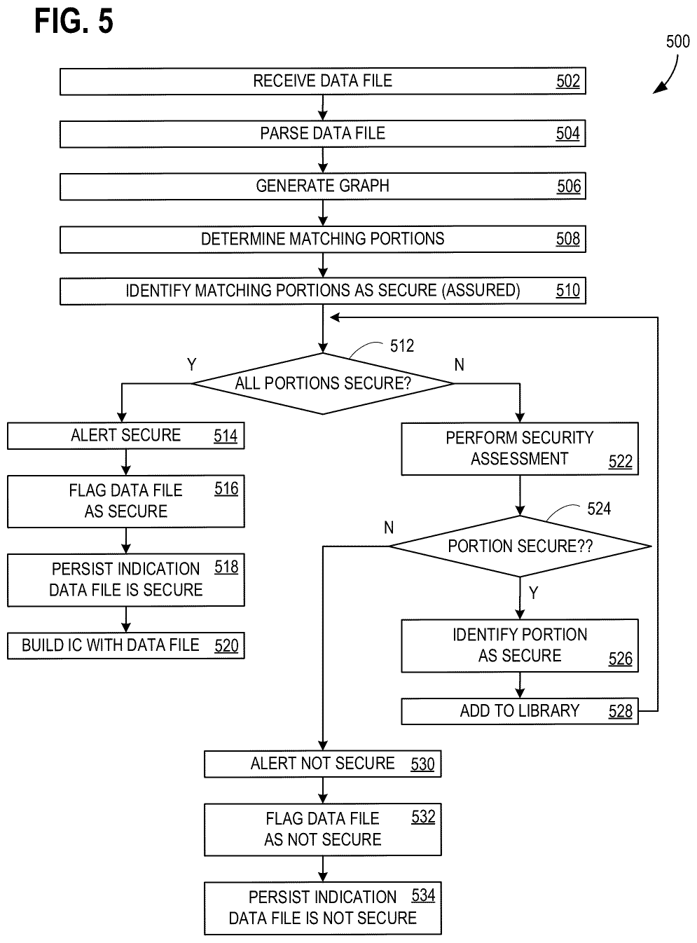

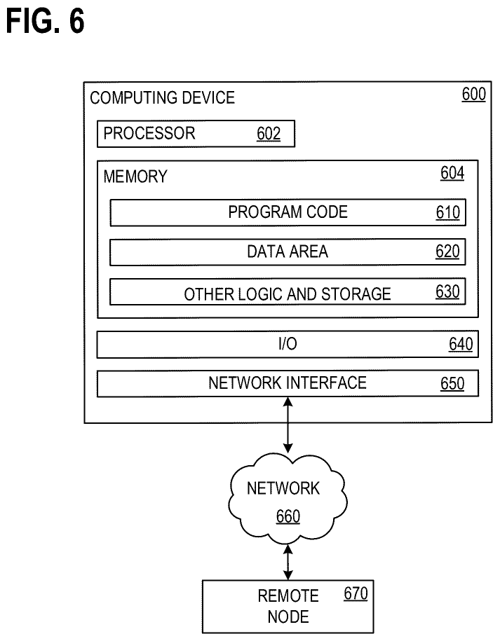

FIG. 5 illustrates a flowchart 500 of exemplary operations associated with examples of architecture 100. In some examples, at least a portion of flowchart 500 may be performed using one or more computing devices 600 of FIG. 6. Flowchart 500 commences with receiving data file 102, identifying components (e.g., primitives 212a and 212b) and connections 214 for a functional component of integrated circuit 112, in operation 502. Data file 102 comprises hard 3PIP, and in some examples, comprises a netlist, a GDS formatted file (e.g., GDSII), or an OASIS formatted file. In some examples, integrated circuit 112 comprises an FPGA or an ASIC.

In operation 504, data file parser 122 parses data file 102 to identify primitives (e.g., primitives 212a and 212b) and connections 214 of the primitives. In some examples, the primitives comprise circuit elements such as transistors, diodes, resistors, capacitors, and inductors. In some examples, connections 214 have multiple sources and destinations. In operation 506, graph generator 124 generates graph 200, in which the nodes of graph 200 (e.g., nodes N1-N4, M1, and M2) correspond to the primitives and the edges of graph 200 (e.g., E1-E6) correspond to connections 214 of the primitives.

In operation 508, graph assessment 126 determines the matching portions of graph 200 (e.g., matching portions 201 and 202). Each matching portion matches any of plurality of subgraphs 310 of subgraph library 300 of known secure functionality. Operation 510 identifies each of matching portions 201 and 202 as secure.

Decision operation 512 determines whether all portions of graph 200 are secure. Decision operation 512 is performed by determining whether any portion of graph 200 is unmatched. For example, unmatched portion 203 is a portion of graph 200 that does not have a match to any subgraph of subgraph library 300.

If there are no unmatched portions (or, in a later pass through decision operation 512, all unmatched portions had been assed as secure in operations 522-526, described below), then flowchart 500 proceeds to operation 514, based on at least identifying that all portions of graph 200 are secure. Operation 514 generates alert 132 that data file 102 is secure, and operation 516 flags data file 102 as secure using a flag 144. Operation 518 persists data file 102 with an indication 145 of data file 102 as secure. Indication 145 may be flag 144 or storage of data file 102 in a specific location, such as assured storage portion 142 of 3PIP storage 140. Integrated circuit 112 is built in operation 520, which comprises FPGA programming, if integrated circuit 112 comprises an FPGA.

If, however, upon the first or subsequent pass, decision operation 512 determines that not all portions of graph 200 are matched, and an unmatched portion (e.g., unmatched portion 203) has not yet been assessed to be secure, flowchart 500 proceeds to operation 522. Operation 522 performs a security assessment of each unmatched portion of graph 200 until all portions are assessed to be secure, or at least one portion is assessed to not be secure. In some examples, operation 522 comprises extracting schematic 410 of unmatched portion 203, performing Boolean analysis 412 of unmatched portion 203, or performing circuit simulation 414 of unmatched portion 203 (e.g., an analog circuit simulation, such as a SPICE simulation).

Decision operation 524 is performed for each unmatched portion and determines whether the current unmatched portion is secure. If decision operation 524 determines that the current unmatched portion (e.g., unmatched portion 203) is secure, operation 526 identifies the unmatched portion as secure. Operation 528 adds the current unmatched portion (e.g., unmatched portion 203) to subgraph library 300, and flowchart 500 returns back to decision operation 512. Next time, subgraph matching is performed, the newly-added portion is available to speed up the process.

If, however, decision operation 524 does not determine that the current unmatched portion is secure, operation 530 generates alert 134 that data file 102 is not secure. Operation 532 then flags data file 102 as not secure using a flag 148. Operation 534 persists data file 102 with an indication 149 of data file 102 as not secure. Indication 149 may be flag 148 or storage of data file 102 in a specific location, such as not-assured storage portion 146 of 3PIP storage 140. In some examples, only a single portion of data file 102 needs to be identified as not secure for the entirety of data file 102 to be identified as not secure.

FIG. 6 illustrates a block diagram of computing device 600 that may be used as any component described herein that may require computational or storage capacity. Computing device 600 has at least a processor 602, and a memory 604 that holds program code 610, data area 620, and other logic and storage 630. Memory 604 is any device allowing information, such as computer executable instructions and/or other data, to be stored and retrieved. For example, memory 604 may include one or more random access memory (RAM) modules, flash memory modules, hard disks, solid-state disks, persistent memory devices, and/or optical disks. Program code 610 comprises computer executable instructions and computer executable components including any instructions necessary to perform operations described herein. Data area 620 holds any data necessary to perform operations described herein. Memory 604 also includes other logic and storage 630 that perform or facilitate other functions disclosed herein or otherwise required of computing device 600. An input/output (I/O) component 640 facilitates receiving input from users and other devices and generating displays for users and outputs for other devices. A network interface 650 permits communication over a network 660 with a remote node 670, which may represent another implementation of computing device 600.

### ADDITIONAL EXAMPLES

An example method of establishing security assurance for an integrated circuit comprises: receiving a data file identifying components and connections for a functional component of an integrated circuit; parsing the data file to identify primitives and connections of the primitives; generating a first graph in which nodes of the first graph correspond to the primitives and edges of the first graph correspond to the connections of the primitives; determining matching portions of the first graph, wherein each matching portion matches any of a plurality of subgraphs of a subgraph library of known secure functionality; identifying each matching portion as secure; and based on at least identifying that all portions of the first graph are secure, generating an alert that the data file is secure.

An example system for establishing security assurance for an integrated circuit comprises: a processor; and a computer-readable medium storing instructions that are operative upon execution by the processor to: receive a data file identifying components and connections for a functional component of an integrated circuit; parse the data file to identify primitives and connections of the primitives; generate a first graph in which nodes of the first graph correspond to the primitives and edges of the first graph correspond to the connections of the primitives; determine matching portions of the first graph, wherein each matching portion matches any of a plurality of subgraphs of a subgraph library of known secure functionality; identify each matching portion as secure; and based on at least identifying that all portions of the first graph are secure, generate an alert that the data file is secure.

Alternatively, or in addition to the other examples described herein, examples include any combination of the following:
based on at least identifying that all portions of the first graph are secure, building the integrated circuit;
based on at least identifying that all portions of the first graph are secure, persisting an indication of the data file as secure;
determining whether any portion of the first graph is unmatched, where an unmatched portion comprises a portion of the first graph that does not have a match to any subgraph of the subgraph library;
for each unmatched portion, performing a security assessment of the unmatched portion;
based on at least the security assessment determining that the unmatched portion is secure, identifying the unmatched portion as secure;
based on at least the security assessment not determining that the unmatched portion is secure, generating an alert that the data file is not secure;
based on at least the security assessment not determining that the unmatched portion is secure, persisting an indication of the data file as not secure;
based on at least determining that the unmatched portion is secure, adding the unmatched portion to the subgraph library;
performing the security assessment comprises extracting a schematic of the unmatched portion;
performing the security assessment comprises performing a Boolean analysis of the unmatched portion;
performing the security assessment comprises performing a circuit simulation of the unmatched portion;
the data file comprises hard 3PIP;
the primitives comprise circuit elements selected from the list consisting of: transistors, diodes, resistors, capacitors, and inductors;
the data file comprises a netlist;
the data file comprises a GDS formatted file;
the GDS formatted file comprises a GDSII formatted file;
the data file comprises an OASIS formatted file;
the integrated circuit comprises an FPGA;
the integrated circuit comprises an ASIC;
based on at least identifying that all portions of the first graph are secure, flagging the data file as secure;
building the integrated circuit comprises programming an FPGA;
the connections of the primitives include connections having multiple sources and destinations;
the circuit simulation comprises an analog circuit simulation; and
the circuit simulation comprises a SPICE simulation.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A method of establishing security assurance for an integrated circuit, the method comprising:
receiving a data file identifying components and connections for a functional component of an integrated circuit;
parsing the data file to identify primitives and connections of the primitives;
generating a first graph in which nodes of the first graph correspond to the primitives and edges of the first graph correspond to the connections of the primitives;
determining matching portions of the first graph, wherein each matching portion matches any of a plurality of subgraphs of a subgraph library of known secure functionality;
identifying each matching portion as secure; and
based on at least identifying that all portions of the first graph are secure, generating an alert that the data file is secure.

2. The method of claim 1, further comprising:
based on at least identifying that all portions of the first graph are secure, building the integrated circuit using the data file.

3. The method of claim 1, further comprising:
determining whether any portion of the first graph is unmatched, where an unmatched portion comprises a portion of the first graph that does not have a match to any subgraph of the subgraph library; and
for each unmatched portion:
performing a security assessment of the unmatched portion; and
either:
based on at least the security assessment determining that the unmatched portion is secure, identifying the unmatched portion as secure; or
based on at least the security assessment not determining that the unmatched portion is secure, generating an alert that the data file is not secure.

4. The method of claim 3, further comprising:
based on at least determining that the unmatched portion is secure, adding the unmatched portion to the subgraph library.

5. The method of claim 3, wherein performing the security assessment comprises:
extracting a schematic of the unmatched portion.

6. The method of claim 3, wherein performing the security assessment comprises:
performing a Boolean analysis of the unmatched portion.

7. The method of claim 3, wherein performing the security assessment comprises:
performing a circuit simulation of the unmatched portion.

8. The method of claim 3, further comprising:
based on at least the security assessment not determining that the unmatched portion is secure, persisting an indication of the data file as not secure.

9. The method of claim 1, further comprising:
based on at least identifying that all portions of the first graph are secure, persisting an indication of the data file as secure.

10. The method of claim 1, wherein the data file comprises hard third party intellectual property (3PIP).

11. The method of claim 1, wherein the primitives comprise circuit elements selected from the list consisting of:
transistors, diodes, resistors, capacitors, and inductors.

12. The method of claim 1, wherein:
the data file comprises a netlist;
the data file comprises a graphic data stream (GDS) formatted file; or
the data file comprises an open artwork system interchange standard (OASIS) formatted file.

13. The method of claim 1, wherein:
the integrated circuit comprises a field programmable gate array (FPGA); or
the integrated circuit comprises an application-specific integrated circuit (ASIC).

14. A system for establishing integrity of digital content, the system comprising:
a processor; and
a computer-readable medium storing instructions that are operative upon execution by the processor to:
receive a data file identifying components and connections for a functional component of an integrated circuit;
parse the data file to identify primitives and connections of the primitives;
generate a first graph in which nodes of the first graph correspond to the primitives and edges of the first graph correspond to the connections of the primitives;
determine matching portions of the first graph, wherein each matching portion matches any of a plurality of subgraphs of a subgraph library of known secure functionality;
identify each matching portion as secure; and
based on at least identifying that all portions of the first graph are secure, generate an alert that the data file is secure.

15. The system of claim 14, wherein the instructions are further operative to:
determine whether any portion of the first graph is unmatched, where an unmatched portion comprises a portion of the first graph that does not have a match to any subgraph of the subgraph library; and
for each unmatched portion:
perform a security assessment of the unmatched portion; and
either:
based on at least the security assessment determining that the unmatched portion is secure, identify the unmatched portion as secure; or
based on at least the security assessment not determining that the unmatched portion is secure, generate an alert that the data file is not secure.

16. The system of claim 15, wherein the instructions are further operative to:
based on at least determining that the unmatched portion is secure, add the unmatched portion to the subgraph library.

17. The system of claim 15, wherein performing the security assessment comprises:
extracting a schematic of the unmatched portion;
performing a Boolean analysis of the unmatched portion; or
performing a circuit simulation of the unmatched portion.

18. The system of claim 15, wherein the instructions are further operative to:
based on at least the security assessment not determining that the unmatched portion is secure, persist an indication of the data file as not secure.

19. The system of claim 14, wherein the instructions are further operative to:
based on at least identifying that all portions of the first graph are secure, persist an indication of the data file as secure.

20. The system of claim 14:
wherein the data file comprises hard third party intellectual property (3PIP);
wherein the primitives comprise circuit elements selected from the list consisting of:
transistors, diodes, resistors, capacitors, and inductors;
the data file comprises a netlist, or a graphic data stream (GDS) formatted file, or an open artwork system interchange standard (OASIS) formatted file; and
the integrated circuit comprises a field programmable gate array (FPGA) or an application-specific integrated circuit (ASIC).
